(19) United States
(12) Patent Application Publication
(10) Pub. No.: US 2005/0221023 A1
(43) Pub. Date: Oct. 6, 2005

(54) Polyimide film and process for producing the same

(76) Inventors: Michie Sakamoto, Ibaraki-shi (JP); Yuuichi Nishikouji, Ibaraki-shi (JP); Nao Murakami, Ibaraki-shi (JP); Masaki Hayashi, Ibaraki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/518,079

(22) PCT Filed: Dec. 24, 2003
(86) PCT No.: PCT/JP03/16643

§ 371 Date: Dec. 16, 2004

(30) Foreign Application Priority Data
Jan. 10, 2003 (JP) 2003-4896

(51) Int. Cl. C09K 19/00

(52) U.S. Cl. 428/1.3

(57) ABSTRACT

A polyimide film having a biaxial optical anisotropy and excellent durability is provided. A solution of polyimide having an imidization ratio of 98% to 100% is applied onto a plastic base, and then the solution is dried, thus forming a polyimide coating. Subsequently, the polyimide coating is stretched together with the plastic base so as to satisfy nx>ny>nz, wherein nx and ny indicate a refractive index in a direction exhibiting a maximum refractive index within a plane and that in a direction perpendicular thereto and nz indicates a refractive index in a thickness direction.

### TECHNICAL FIELD

The present invention relates to a polyimide film and a method for producing the same.

### BACKGROUND ART

Because of its excellent physical properties such as an extremely high thermal stability, polyimide is used in various applications including films, various forming materials and adhesives (see Japanese Patent 2688698, U.S. Pat. No. 5,344,916, JP 2000-190385 A and JP 2002-60620 A, for example). In particular, fluorine-based polyimide has an excellent light transmittance when processed into a film and thus is suitable for an optical material (see Japanese Patent 2688698, U.S. Pat. No. 5,344,916 and JP 2000-190385 A, for example). With a view to obtaining higher performance optical films, studies have been conducted intensively to control optical anisotropies of polyimide films and improve optical characteristics and durability thereof. Accordingly, polyimide films having excellent characteristics are in demand. Especially, polyimide films having a biaxial optical anisotropy could serve as a useful optical material. However, there has been no disclosure of such films having a sufficient durability yet.

### DISCLOSURE OF INVENTION

Thus, it is an object of the present invention to provide a polyimide film that has a biaxial optical anisotropy and an excellent durability.

In order to solve the above-mentioned problem, a polyimide film of the present invention includes polyimide whose imidization ratio ranges from 98% to 100% and satisfies an optical characteristic condition represented by the formula (1) below. In the formula (1), nx, ny and nz respectively indicate refractive indices in an X-axis direction, a Y-axis direction and a Z-axis direction in the polyimide film, with the X axis corresponding to an axial direction exhibiting a maximum refractive index within a surface of the polyimide film, the Y axis corresponding to an axial direction perpendicular to the X axis within the surface, and the Z axis corresponding to a thickness direction perpendicular to the X axis and the Y axis. It is needless to say that, in the formula (1), nx, ny and nz are all measured at the same wavelength.
nx>>ny>nz (1)

### BEST MODE FOR CARRYING OUT THE INVENTION

The following is a description of an embodiment of the present invention.

(Polyimide and its Producing Method)

First, polyimide used for a polyimide film of the present invention and its producing method will be described.

The polyimide film of the present invention is excellent in stability during a long period of storage, moisture resistance and thermal resistance because an imidization ratio of polyimide ranges from 98% to 100%.

Polyimide used for the polyimide film of the present invention is not particularly limited as long as its imidization ratio ranges from 98% to 100% but preferably is polyimide that has a high in-plane alignment and is soluble in an organic solvent. More specifically, it is possible to use, for example, a condensation polymer of 9,9-bis(aminoaryl)fluorene and an aromatic tetracarboxylic dianhydride disclosed in JP 2000-511296 A, namely, a polymer containing at least one repeating unit represented by the formula (I) below.

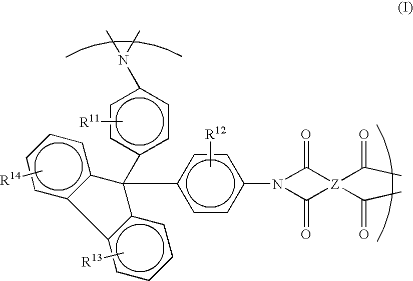

In the above formula (I), R¹¹ to R¹⁴ are at least one substituent selected independently from the group consisting of hydrogen, halogen, a phenyl group, a phenyl group substituted with 1 to 4 halogen atoms or a C₁₋₁₀ alkyl group, and a C₁₋₁₀ alkyl group. Preferably, R¹¹ to R¹⁴ are at least one substituent selected independently from the group consisting of halogen, a phenyl group, a phenyl group substituted with 1 to 4 halogen atoms or a C_{1 -10} alkyl group, and a C₁₋₁₀ alkyl group.

In the above formula (I), Z is, for example, a C₆₋₂₀ quadrivalent aromatic group, and preferably is a pyromellitic group, a polycyclic aromatic group, a derivative of a polycyclic aromatic group or a group represented by the formula (2) below.

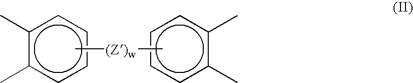

In the formula (II) above, Z′ is, for example, a covalent bond, a C(R¹⁵)₂ group, a CO group, an O atom, an S atom, an SO₂ group, an Si(C₂H₅)₂ group or an NR¹⁶ group. When there are plural Z's, they may be the same or different. Also, w is an integer from 1 to 10. R¹⁵s independently are hydrogen or C(R¹⁷)₃. R¹⁶ is hydrogen, an alkyl group having from 1 to about 20 carbon atoms or a C₆₋₂₀ aryl group, and when there are plural R¹⁶s, they may be the same or different. R¹⁷s independently are hydrogen, fluorine or chlorine.

The above-mentioned polycyclic aromatic group may be, for example, a quadrivalent group derived from naphthalene, fluorene, benzofluorene or anthracene. Further, a substituted derivative of the above-mentioned polycyclic aromatic group may be the above-mentioned polycyclic aromatic group substituted with at least one group selected from the group consisting of, for example, a C₁₋₁₀ alkyl group, a fluorinated derivative thereof and halogen such as F and Cl.

Other than the above, homopolymer whose repeating unit is represented by the general formula (III) or (IV) below or polyimide whose repeating unit is represented by the general formula (V) below disclosed in JP 8(1996)-511812 A may be used, for example. The polyimide represented by the formula (V) below is a preferable mode of the homopolymer represented by the formula (III).

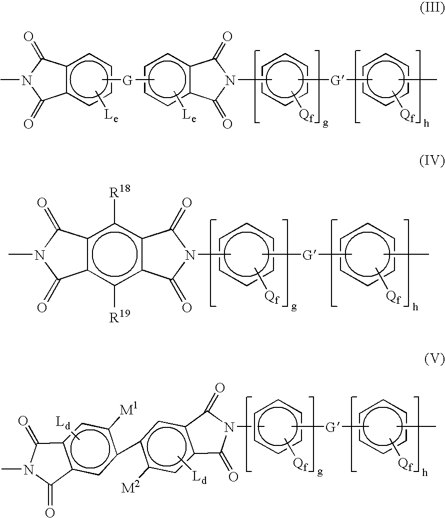

In the above general formulae (III) to (V), G and G′ each are a group selected independently from the group consisting of, for example, a covalent bond, a CH₂ group, a C(CH₃)₂ group, a C(CF₃)₂ group, a C(CX₃)₂ group (wherein X is halogen), a CO group, an O atom, an S atom, an SO₂ group, an Si(CH₂CH₃)₂ group and an N(CH₃) group, and G and G′ may be the same or different.

In the above formulae (III) and (V), L is a substituent, and d and e indicate the number of substitutions therein. L is, for example, halogen, a C₁₋₃ alkyl group, a halogenated C₁₋₃ alkyl group, a phenyl group or a substituted phenyl group, and when there are plural Ls, they may be the same or different. The above-mentioned substituted phenyl group may be, for example, a substituted phenyl group having at least one substituent selected from the group consisting of halogen, a C₁₋₃ alkyl group and a halogenated C₁₋₃ alkyl group. Also, the above-mentioned halogen may be, for example, fluorine, chlorine, bromine or iodine. d is an integer from 0 to 2, and e is an integer from 0 to 3.

In the above formulae (III) to (V), Q is a substituent, and f indicates the number of substitutions therein. Q may be, for example, an atom or a group selected from the group consisting of hydrogen, halogen, an alkyl group, a substituted alkyl group, a nitro group, a cyano group, a thioalkyl group, an alkoxy group, an aryl group, a substituted aryl group, an alkyl ester group and a substituted alkyl ester group and, when there are plural Qs, they may be the same or different. The above-mentioned halogen may be, for example, fluorine, chlorine, bromine or iodine. The above-mentioned substituted alkyl group may be, for example, a halogenated alkyl group. Also, the above-mentioned substituted aryl group may be, for example, a halogenated aryl group. f is an integer from 0 to 4, and g and h respectively are an integer from 0 to 3 and an integer from 1 to 3. Furthermore, it is preferable that g and h are larger than 1.

In the above formula (IV), R¹⁸ and R¹⁹ are groups selected independently from the group consisting of hydrogen, halogen, a phenyl group, a substituted phenyl group, an alkyl group and a substituted alkyl group. It is particularly preferable that R¹⁸ and R¹⁹ independently are a halogenated alkyl group.

In the above formula (V), M¹ and M² may be the same or different and, for example, halogen, a C₁₋₃ alkyl group, a halogenated C₁₋₃ alkyl group, a phenyl group or a substituted phenyl group. The above-mentioned halogen may be, for example, fluorine, chlorine, bromine or iodine. The above-mentioned substituted phenyl group may be, for example, a substituted phenyl group having at least one substituent selected from the group consisting of halogen, a Cl ˜3 alkyl group and a halogenated C₁₋₃ alkyl group.

Moreover, the above-mentioned polyimide may be, for example, copolymer obtained by copolymerizing acid dianhydride and diamine other than the above-noted skeleton (the repeating unit) suitably.

The above-mentioned acid dianhydride may be, for example, aromatic tetracarboxylic dianhydride. The aromatic tetracarboxylic dianhydride may be, for example, pyromellitic dianhydride, benzophenone tetracarboxylic dianhydride, naphthalene tetracarboxylic dianhydride, heterocyclic aromatic tetracarboxylic dianhydride or 2,2′-substituted biphenyl tetracarboxylic dianhydride.

The pyromellitic dianhydride may be, for example, pyromellitic dianhydride, 3,6-diphenyl pyromellitic dianhydride, 3,6-bis(trifluoromethyl)pyromellitic dianhydride, 3,6-dibromopyromellitic dianhydride or 3,6-dichloropyromellitic dianhydride. The benzophenone tetracarboxylic dianhydride may be, for example, 3,3′,4,4′-benzophenone tetracarboxylic dianhydride, 2,3,3′, 4′-benzophenone tetracarboxylic dianhydride or 2,2′,3,3′-benzophenone tetracarboxylic dianhydride. The naphthalene tetracarboxylic dianhydride may be, for example, 2,3,6,7-naphthalene-tetracarboxylic dianhydride, 1,2,5,6-naphthalene-tetracarboxylic dianhydride or 2,6-dichloro-naphthalene-1,4,5,8-tetracarboxylic dianhydride. The heterocyclic aromatic tetracarboxylic dianhydride may be, for example, thiophene-2,3,4,5-tetracarboxylic dianhydride, pyrazine-2,3,5,6-tetracarboxylic dianhydride or pyridine-2,3,5,6-tetracarboxylic dianhydride. The 2,2′-substituted biphenyl tetracarboxylic dianhydride may be, for example, 2,2′-dibromo-4,4′,5,5′-biphenyl tetracarboxylic dianhydride, 2,2′-dichloro-4,4′, 5,5′-biphenyl tetracarboxylic dianhydride or 2,2′-bis(trifluoromethyl)-4,4′, 5,5′-biphenyl tetracarboxylic dianhydride.

Other examples of the aromatic tetracarboxylic dianhydride may include 3,3′,4,4′-biphenyl tetracarboxylic dianhydride, bis(2,3-dicarboxyphenyl)methane dianhydride, bis(2,5,6-trifluoro-3,4-dicarboxyphenyl)methane dianhydride, 2,2-bis(3,4-dicarboxyphenyl)-1,1,1,3,3,3-hexafluoropropane dianhydride, 4,4′-bis(3,4-dicarboxyphenyl)-2,2-diphenylpropane dianhydride, bis(3,4-dicarboxyphenyl)ether dianhydride, 4,4′-oxydiphthalic dianhydride, bis(3,4-dicarboxyphenyl)sulfonic dianhydride, 3,3′,4,4′-diphenylsulfone tetracarboxylic dianhydride, 4,4′-[4,4′-isopropylidene-di(p-phenyleneoxy)]bis(phthalic dianhydride), N,N-(3,4-dicarboxyphenyl)-N-methylamine dianhydride and bis(3,4-dicarboxyphenyl)diethylsilane dianhydride.

Among the above, the aromatic tetracarboxylic dianhydride preferably is 2,2′-substituted biphenyl tetracarboxylic dianhydride, more preferably is 2,2′-bis(trihalomethyl)-4,4′, 5, 5′-biphenyl tetracarboxylic dianhydride, and further preferably is 2,2′-bis(trifluoromethyl)-4,4′,5,5′-biphenyl tetracarboxylic dianhydride.

The above-mentioned diamine may be, for example, aromatic diamine. Specific examples thereof include benzenediamine, diaminobenzophenone, naphthalenediamine, heterocyclic aromatic diamine and other aromatic diamines.

The benzenediamine may be, for example, diamine selected from the group consisting of benzenediamines such as o-, m- and p-phenylenediamine, 2,4-diaminotoluene, 1,4-diamino-2-methoxybenzene, 1,4-diamino-2-phenylbenzene and 1,3-diamino-4-chlorobenzene. Examples of the diaminobenzophenone may include 2,2′-diaminobenzophenone and 3,3′-diaminobenzophenone. The naphthalenediamine may be, for example, 1,8-diaminonaphthalene or 1,5-diaminonaphthalene. Examples of the heterocyclic aromatic diamine may include 2,6-diaminopyridine, 2,4-diaminopyridine and 2,4-diamino-S-triazine.

Further, other than the above, the aromatic diamine may be 4,4′-diaminobiphenyl, 4,4′-diaminodiphenylmethane, 4,4′-(9-fluorenylidene)-dianiline, 2,2′-bis(trifluoromethyl)-4,4′-diaminobiphenyl, 3,3′-dichloro-4,4′-diaminodiphenylmethane, 2,2′-dichloro-4,4′-diaminobiphenyl, 2,2′, 5,5′-tetrachlorobenzidine, 2,2-bis(4-aminophenoxyphenyl)propane, 2,2-bis(4-aminophenyl)propane, 2,2-bis(4-aminophenyl)-1,1,1,3,3,3-hexafluoropropane, 4,4′-diamino diphenyl ether, 3,4′-diamino diphenyl ether, 1,3-bis(3-aminophenoxy)benzene, 1,3-bis(4-aminophenoxy)benzene, 1,4-bis(4-aminophenoxy)benzene, 4,4′-bis(4-aminophenoxy)biphenyl, 4,4′-bis(3-aminophenoxy)biphenyl, 2,2-bis [4-(4-aminophenoxy)phenyl]propane, 2,2-bis [4-(4-aminophenoxy)phenyl]-1,1,1,3,3,3-hexafluoropropane, 4,4′-diamino diphenyl thioether or 4,4′-diaminodiphenylsulfone.

Further, it is preferable that the polyimide used for the polyimide film of the present invention is polyimide whose molecule contains a fluorine atom, namely, so-called fluorine-based polyimide. The reason is that, since the fluorine-based polyimide has particularly good light transmittance among other polyimides and has relatively high solubility in various organic solvents, it can be processed into a film easily.

It is preferable for achieving still better light transmittance and solubility that the above-noted fluorine-based polyimide is polyimide obtained by allowing carboxylic dianhydride represented by the general formula (VI) below and diamine represented by the general formula (VII) below to react so as to produce a polyamic acid and then imidizing this polyamic acid.

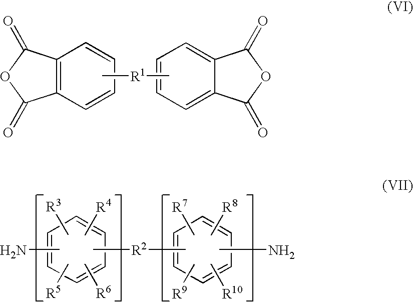

In the formulae (VI) and (VII),
R¹ is a methylene group optionally substituted with a fluorine atom or an isopropylidene group (i.e., a C(CH₃)₂ group), or no R¹ is present,
R² is a methylene group optionally substituted with a fluorine atom or an isopropylidene group (i.e., a C(CH₃)₂ group), or no R² is present,
R³ to R¹⁰ individually are hydrogen or a methyl group optionally substituted with a fluorine atom and may be the same or different,
at least one of R¹ to R¹⁰ is a group containing a fluorine atom, and
p and q individually are any integer from 0 to 3, and q is any integer from 1 to 3 when p=0.

It is further preferable that the above formulae (VI) and (VII) satisfy the conditions below. In other words, it is further preferable that
R¹ is a hexafluoroisopropylidene group (i.e., a C(CF₃)₂ group), or no R is present,
R² is a hexafluoroisopropylidene group (i.e., a C(CF₃)₂ group), or no R² is present,
R³ to R¹⁰ individually are hydrogen or a trifluoromethyl group and may be the same or different, and
at least one of R¹ to R¹⁰ is a group containing a fluorine atom.

In the above—noted fluorine—based polyimide, it is particularly preferable that the carboxylic dianhydride represented by the general formula (VI) above is 2,2-bis(3,4-dicarboxyphenyl)-hexafluoropropane dianhydride (the chemical compound represented by the formula (VIII) below) and the diamine represented by the general formula (VII) above is 2,2-bis(trifluoromethyl)-4,4′-diaminobiphenyl (the chemical compound represented by the formula (IX) below). This polyimide has particularly high light transmittance and solubility in various organic solvent among the polyimides listed above.

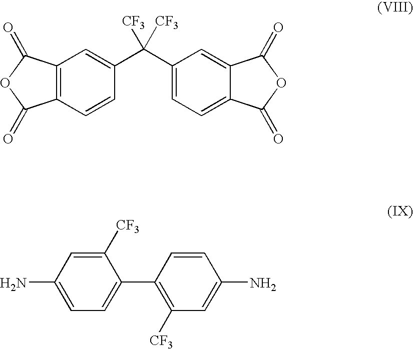

Although there is no particular limitation on the method for producing polyimide used for the polyimide film of the present invention, producing methods such as so-called thermal imidization and chemical imidization can be adopted, for example.

The thermal imidization can be carried out according to the description in U.S. Pat. No. 5,344,916, for example. More specifically, first, equivalent moles of the above-described carboxylic dianhydride and the above-described diamine are put into a flask, to which a high-boiling solvent is added and stirred at room temperature, thus preparing a mixed solution. At this time, it is preferable that a catalyst for enhancing the formation of polyimide is mixed as well. As the above-noted high-boiling solvent, it is possible to use aromatic solvents such as nitrobenzene, benzonitrile and α-chloronaphthalene, phenolic solvents such as phenol, o-cresol, m-cresol, p-cresol, o-chlorophenol, m-chlorophenol and p-chlorophenol, and amide-based solvents such as N-methylpyrrolidone, for example. These solvents may be used alone or in combination of two or more. The above-mentioned catalyst can be, for example, an aromatic carboxylic acid such as a benzoic acid or a p-hydroxybenzoic acid or an aromatic amine such as isoquinoline.

Next, the above-described solution is heated and stirred to proceed reaction, so that the carboxylic dianhydride and the diamine are condensed to produce a polyamic acid, thus forming polyimide. At this time, the reaction temperature is, for example, 150° C. to 250° C., and the reaction time is, for example, 2 to 8 hours. Since insufficient reaction temperature or time lowers polymerization degree or imidization ratio, the heating and stirring are carried out until the polymerization and imidization fully proceed. By this method, it is possible to achieve an imidization ratio as high as 98% to 100%.

Instead of adding the above-noted catalyst, a solvent that is azeotropic with water may be used as the high-boiling solvent, whereby water formed at the time of reaction can be removed efficiently by azeotrope to the outside of the reaction system so as to enhance reaction. As the high-boiling solvent that is azeotropic with water, o-dichlorobenzene, N-cyclohexylpyrrolidone and xylene can be used, for example.

After the completion of the reaction, polyimide is isolated. The method therefor is not particularly limited but preferably is a so-called reprecipitation method, for example. More specifically, first, the mixed solution is cooled down to the room temperature. At this time, polyimide precipitates in a gel form in some cases. Thus, the solution is diluted by an appropriate solvent, for example, acetone as necessary, or polyimide is once dissolved completely by heating to a suitable temperature, for example, 40° C. to 50° C. Conversely, when the concentration of the mixed solution is too low, it may be possible to once concentrate the solution and then cool it down to the room temperature. Next, while agitating a large amount of prepared alcohol, lower hydrocarbons or the like, the above-noted mixed solution that has been cooled down to the room temperature is added little by little, thus allowing polyimide to precipitate. This polyimide is collected by filtration and dried, thereby obtaining powder of a desired product. In this manner, polyimide can be synthesized by the thermal imidization.

The chemical imidization can be carried out according to the description in JP 2002-60620 A, for example. More specifically, first, equivalent moles of the above-described carboxylic dianhydride and the above-described diamine are put into a flask and stirred at room temperature while further adding DMAc (dimethylacetamide) until they are completely dissolved. Subsequently, this solution is stirred while heating or cooling as necessary, thereby producing a polyamic acid. At this time, the reaction temperature is, for example, 0° C. to 80° C., and the reaction time is, for example, 3 to 24 hours.

Then, an imidization agent and a dehydrator respectively are added in at least twice as much mole amount as the carboxylic dianhydride or the diamine, followed by further stirring to proceed imidization. The above-mentioned imidization agent can be, for example, quarternary amine such as pyridine or triethylamine. The above-mentioned dehydrator can be, for example, acetic anhydride, trifluoroacetic anhydride or DCC (dicyclohexylcarbodiimide) but preferably is acetic anhydride considering costs. At this time, the reaction temperature is, for example, 0° C. to 100° C., and the reaction time is, for example, 3 to 24 hours. Since insufficient reaction temperature or reaction time leads to low imidization ratio, the reaction is allowed to continue until the imidization proceeds fully. By this method, it is also possible to achieve an imidization ratio as high as 98% to 100%.

After the completion of the reaction, desired polyimide is isolated by a reprecipitation method or the like similarly to the case of thermal imidization described above. In this manner, polyimide can be synthesized by the chemical imidization.

Since the polyimide synthesized as above has a high imidization ratio, it has excellent stability during a long period of storage and can be stored as a powder form for a long time. Further, there is an advantage in that, because of its high imidization ratio, the polyimide is soluble relatively easily in a solvent having a relatively low polarity. Polyimide generally is not easily soluble in a solvent other than a high-polarity solvent (for example, N-methylpyrrolidone, dimethylacetamide, dimethylformamide and the like). Therefore, when its solution is applied to a plastic base or the like, the high-polarity solvent may erode the base. On the other hand, such an erosion can be avoided if it is possible to use a solvent having a relatively low polarity, so that processing becomes easier.

In a polyimide film of the present invention, it is preferable that the polyimide has a weight-average molecular weight ranging from 50000 to 180000. The weight-average molecular weight of equal to or greater than 50000 achieves excellent fracture strength, while that of equal to or lower than 180000 does not raise the viscosity of a solution of the polyimide excessively and thus allows easy application. The method for obtaining polyimide having an appropriate weight-average molecular weight is not particularly limited but may be either of the thermal imidization or the chemical imidization, for example. However, the chemical imidization is more preferable because the resultant polyimide easily achieves higher transparency. Incidentally, at the time of imidization, a terminator such as a monocarboxylic acid or monoamine may be used suitably for the purpose of preventing the weight-average molecular weight of the polyimide from rising excessively.

In the polyimide film of the present invention, the fracture strength preferably is equal to or greater than 100 N/mm², more preferably is equal to or greater than 105 N/mm² and particularly preferably is equal to or greater than 110 N/mm² under a measurement condition of a pulling speed of 5 m/min, a sample width of 10 mm and a chuck-to-chuck distance of 50 mm. Although the upper limit of the fracture strength is not particularly limited, it is equal to or lower than 150 N/mm², for example.

(Producing Method and Use Mode of Polyimide Film)

The following description is directed to a producing method and a use mode of the polyimide film of the present invention.

Although there is no particular limitation on the producing method of the polyimide film of the present invention, the polyimide film can be produced by, for example, a producing method according to the present invention including the steps (A) and (B) below.
(A) the step of applying a solution of polyimide having an imidization ratio of 98% to 100% onto a plastic base and drying the solution, thus forming a polyimide coating.
(B) the step of stretching the polyimide coating together with the plastic base so as to satisfy the formula (1) above.

Although the polyimide used in the producing method of the present invention is not particularly limited as long as it has an imidization ratio of 98% to 100%, the above-described polyimide is preferable. The stretching condition is not particularly limited but may be a uniaxial stretching or a biaxial stretching. The uniaxial stretching is usually sufficient for satisfying the formula (1) above, but the biaxial stretching also may be employed. Further, there is no particular limitation on a specific stretching method, and a known method can be employed suitably. For example, it is possible to adopt a roller longitudinal stretching, a tenter transverse stretching or the like.

In the producing method of the present invention, the solvent of the polyimide solution may be used alone or in combination of two or more. It is preferable that the solvent of the polyimide solution has a solubility parameter ranging from 17 to 22 under a measurement condition of a pressure of 1 atmosphere and an atmospheric temperature of 25° C. The solubility parameter is a value δ represented by the equation (2) below. In the equation (2), AH and V respectively indicate molar heat of vaporization and molar volume of the solvent.
δ=(ΔH/V)^{1/2} (2)
Incidentally, data of the solubility parameters of various solvents are listed in “Polymer Handbook” 4th Edition, WILEY-INTERSCIENCE.

When the solubility parameter is equal to or smaller than 22, the solvent does not erode the plastic base easily, so that the surface of the polyimide film achieves excellent smoothness, which is more suitable for optical applications. Also, the plastic base is not easily fractured during stretching. Furthermore, although the soluble property of polyimide varies depending on its chemical structure, even polyimide having a structure that is poorly soluble in an organic solvent is dissolved relatively easily when the solubility parameter is equal to or larger than 17. The solubility parameter more preferably is 17.1 to 21.5 and particularly preferably is 17.2 to 21.3.

It is preferable that the temperature at which the polyimide solution is dried in the step (A) is equal to or lower than 200° C., because the plastic base does not change, for example, melt easily. The drying temperature more preferably is 180° C. or lower and particularly preferably is 160° C. or lower. The lower limit of the drying temperature is not particularly limited but preferably is equal to or higher than 50° C. in view of the production efficiency of polyimide films.

It is preferable that a solvent of the polyimide solution contains at least one solvent selected from the group consisting of ester, ketone and ether, for example. Also, it is more preferable that the ester contains at least one selected from the group consisting of ethyl acetate, propyl acetate, butyl acetate, isobutyl acetate, butyl propionate and caprolactone, the ketone contains at least one selected from the group consisting of acetone, methyl ethyl ketone, methyl propyl ketone, methyl isopropyl ketone, methyl isobutyl ketone, diethyl ketone, cyclopentanone, cyclohexanone and methylcyclohexanone, and the ether contains at least one selected from the group consisting of methyl ether (dimethyl ether), diethyl ether, dibutyl ether, dichloroethyl ether, furan, tetrahydrofuran, diphenyl ether, dibenzyl ether, ethylene glycol monoethyl ether, ethylene glycol butyl ether, propylene glycol methyl ether, diethylene glycol monobutyl ether and tripropylene glycol.

Although the plastic base is not particularly limited but preferably is a thermoplastic resin considering an easiness of stretching. Also, the base may be formed of a single plastic or a combination of two or more plastics. For example, an extrudate of mixed resin compositions can be used. It is preferable that the plastic base contains at least one selected from the group consisting of polyester, cellulose ester, polyolefin, substituted polyolefin, polycarbonate and polysulfone, for example.

In the present invention, “substituted polyolefin” refers to polyolefin whose side chain contains a hetero element (element that is neither carbon nor hydrogen). Specific examples of the substituted polyolefin include polyolefin containing substituted or unsubstituted imido bond(s) and polyolefin containing substituted or unsubstituted phenyl group(s) and cyano group(s). The above-noted polyolefin containing substituted or unsubstituted imido bond(s) is, for example, an isobutene-N-methylmaleimide copolymer. The above-noted polyolefin containing substituted or unsubstituted phenyl group(s) and cyano group(s) is, for example, an acrylonitrile-styrene copolymer.

Further, the term “polycarbonate” either refers to a polymer with a structure obtained by copolymerizing bisphenol A and a carbonic acid derivative (namely, polycarbonate of bisphenol A) or generically refers to polymers whose principal chain contains a carbonate bond. The latter applies in the present invention.

In the plastic base, it is more preferable that the polyester contains at least one selected from the group consisting of polyethylene terephthalate, polyethylene isophthalate, 1,4-cyclohexanedimethylene terephthalate, polybutylene terephthalate and polyethylene naphthalate, the cellulose ester contains at least one selected from the group consisting of triacetylcellulose, cellulose propionate and cellulose butyrate, the polyolefin contains at least one selected from the group consisting of polynorbornene, polyethylene, polypropylene and polystyrene, the substituted polyolefin contains at least one of isobutene-N-methylmaleimide copolymer and acrylonitrile-styrene copolymer, the polycarbonate contains at least one selected from the group consisting of polycarbonate of bisphenol A, polycarbonate of bisphenol C (2,2-bis(4-hydroxyphenyl)-1,1-dichloroethylene), polycarbonate of alkylidenebisphenol and polycarbonate of cycloalkylidenebisphenol, the polysulfone contains at least one selected from the group consisting of polyethersulfone, polyarylethersulfone, polyphenylsulfone and bisphenol A polysulfone.

There are many specific examples that are preferable for the plastic base. For example, a film formed of a resin composition containing an isobutene-N-methylmaleimide copolymer and an acrylonitrile-styrene copolymer is preferable.

When the polyimide film produced by the producing method of the present invention is used for an optical film, it may be kept as one piece with the plastic base or separated from the plastic base before use. Although there is no particular limitation on the method for separating the plastic base and the polyimide film, the following method may be employed, for example. Another glass substrate or plastic substrate is prepared, and an adhesive or the like is applied thereon. The applied surface and the polyimide film are brought into close contact with each other, and the plastic base is peeled off from the polyimide film (this operation is sometimes referred to as “transferring”). In the case where the polyimide film and the plastic base are used as one piece for the optical film, it is preferable that the plastic base has excellent light transmittance. More specifically, the plastic base preferably has a light transmittance of equal to or higher than 90% with respect to light with wavelengths of 400 to 700 nm and more preferably has a light transmittance of equal to or higher than 90% with respect to light with wavelengths of 300 to 800 nm. Although the light transmittance has no particular upper limit, higher transmittance is more advantageous in terms of function of the optical film, and it is ideally 100%.

The optical film of the present invention includes a polyimide layer formed of the polyimide film according to the present invention and thus has excellent optical characteristics. An optical element of the present invention is an optical element whose one surface or both surfaces are laminated with the polyimide film of the present invention or the optical film of the present invention. Other constituent elements are not particularly limited, and one or more constituent elements may be included optionally. In the following, specific examples of the constituent elements will be described.

The above-mentioned constituent element in the optical element of the present invention is, for example, a polarizer (a polarizing film). The polarizer is not particularly limited but can be a film prepared by a conventionally known method of, for example, dyeing by allowing a film of various kinds to adsorb a dichroic material such as iodine or a dichroic dye, followed by cross-linking, stretching and drying. Especially, films that transmit linearly polarized light when natural light is made to enter those films are preferable, and films having excellent light transmittance and polarization degree are preferable. Examples of the film of various kinds in which the dichroic material is to be adsorbed include hydrophilic polymer films such as polyvinyl alcohol (PVA)-based films, partially-formalized PVA-based films, partially-saponified films based on ethylene-vinyl acetate copolymer and cellulose-based films. Other than the above, polyene aligned films such as dehydrated PVA and dehydrochlorinated polyvinyl chloride can be used, for example. Among them, the PVA-based film is preferable. In addition, the thickness of the polarizer ranges, for example, from 1 to 80 μm, though it is not limited to this.

It is also preferable to provide a protective layer on one surface or both surfaces of the polarizer for use as a polarizing plate. The protective layer is not particularly limited but can be a conventionally known transparent film. For example, transparent films having excellent transparency, mechanical strength, thermal stability, moisture shielding property and isotropism are preferable. Specific examples of materials for such a protective layer can include cellulose-based resins such as triacetylcellulose (TAC), and transparent resins based on polyester, polycarbonate, polyamide, polyimide, polyethersulfone, polysulfone, polystyrene, polynorbornene, polyolefin, acrylic substances, acetate and the like. Thermosetting resins or ultraviolet-curing resins based on the acrylic substances, urethane, acrylic urethane, epoxy, silicones and the like can be used as well. Among them, a TAC film having a surface saponified with alkali or the like is preferable in view of the polarization property and durability.

Other than the above, a material for the protective layer can be the polymer film described in JP 2001-343529 A (WO 01/37007). This polymer material can be a resin composition containing a thermoplastic resin whose side chain has substituted or unsubtituted imido group(s) and a thermoplastic resin whose side chain has substituted or unsubtituted phenyl group(s) and cyano group(s), for example, a resin composition containing an alternating copolymer of isobutene and N-methylmaleimide and an acrylonitrile-styrene copolymer. Alternatively, the polymer film may be formed by extruding the resin composition.

It is preferable that the protective layer is colorless. More specifically, a retardation value in its thickness direction (Rth) preferably ranges from −90 nm to +75 nm, more preferably ranges from −80 nm to +60 nm, and particularly preferably ranges from −70 nm to +45 nm. When the retardation value is within the range of −90 nm to +75 nm, coloration (optical coloration) of the polarizing plate, which is caused by the protective layer, can be solved sufficiently. In this case, the retardation value (Rth) is represented by the equation (3) below.
Rth=[{(nx′+ny′)/2}−nz′]×d (3)
In the equation above, nx′, ny′and nz′ respectively indicate refractive indices in an X-axis direction, a Y-axis direction and a Z-axis direction in the protective layer. The X axis corresponds to an axial direction exhibiting a maximum refractive index within the surface of the protective layer, the Y axis corresponds to an axial direction perpendicular to the X axis within the surface, and the Z axis corresponds to a thickness direction perpendicular to the X axis and the Y axis. Further, d indicates the thickness of the protective layer.

The protective layer further may have an optically compensating function. As such a protective layer having the optically compensating function, it is possible to use, for example, a known layer used for preventing coloration caused by changes in a visible angle based on retardation in a liquid crystal cell or for widening a preferable viewing angle. Specific examples include various films obtained by stretching the above-described transparent resins uniaxially or biaxially, an aligned film of a liquid crystal polymer or the like, and a laminate obtained by providing an aligned layer of a liquid crystal polymer or the like on a transparent base. Among the above, the aligned film of a liquid crystal polymer is preferable because a wide viewing angle with excellent visibility can be achieved. Particularly preferable is an optically compensating retardation plate obtained by supporting an optically compensating layer with the above-mentioned triacetylcellulose film or the like, where the optically compensating layer is made of an incline-aligned layer of a discotic or nematic liquid crystal polymer. This optically compensating retardation plate can be a commercially available product, for example, “UV film (trade name)” manufactured by Fuji Photo Film Co., Ltd. Alternatively, the optically compensating retardation plate can be prepared by laminating two or more layers of the retardation film and the film support of triacetylcellulose film or the like so as to control the optical characteristics such as retardation.

In the case where the polyimide film produced by the producing method of the present invention is used as one piece with the plastic base, the plastic base also can serve as the protective layer of the polarizer.

The thickness of the protective layer is not particularly limited but can be determined suitably according to retardation or protection strength, for example. For example, the thickness is in the range not greater than 500 μm, preferably from 3 to 500 μm, and more preferably from 5 to 150 μm.

The protective layer can be formed suitably by a conventionally known method such as a method of coating a polarizer with the above-mentioned various transparent resins or a method of laminating the transparent resin film, the optically compensating retardation plate or the like on the polarizer, or can be a commercially available product.

The protective layer further may be subjected to, for example, a hard coating treatment, an antireflection treatment, treatments for anti-sticking, diffusion and anti-glaring and the like. The hard coating treatment aims at preventing scratches on the surfaces of the polarizing plate, and is a treatment of, for example, providing a hardened coating film that is formed of a curable resin and has excellent hardness and smoothness onto a surface of the protective layer. The curable resin can be, for example, ultraviolet-curing resins of silicone base, urethane base, acrylic, and epoxy base. The treatment can be carried out by a conventionally known method. The anti-sticking treatment aims at preventing adjacent layers from sticking to each other. The antireflection treatment aims at preventing reflection of external light on the surface of the polarizing plate, and can be carried out by forming a conventionally known antireflection layer or the like.

The anti-glare treatment aims at preventing reflection of external light on the polarizing plate surface from hindering visibility of light transmitted through the polarizing plate. The anti-glare treatment can be carried out, for example, by providing microscopic asperities on a surface of the protective layer by a conventionally known method. Such microscopic asperities can be provided, for example, by roughening the surface by sand-blasting or embossing, or by blending transparent fine particles in the above-described transparent resin when forming the transparent protective layer.

The above-described transparent fine particles may be silica, alumina, titania, zirconia, stannic oxide, indium oxide, cadmium oxide, antimony oxide or the like. Other than the above, inorganic fine particles having an electrical conductivity or organic fine particles comprising, for example, crosslinked or uncrosslinked polymer particles can be used as well. The average particle diameter of the transparent fine particles ranges, for example, from 0.5 to 20 μm, though there is no specific limitation. In general, a blend ratio of the transparent fine particles preferably ranges from 2 to 70 parts by weight, and more preferably ranges from 5 to 50 parts by weight with respect to 100 parts by weight of the above-described transparent resin, though there is no specific limitation.

An anti-glare layer in which the transparent fine particles are blended can be used as the protective layer itself or provided as a coating layer applied onto the protective layer surface. Furthermore, the anti-glare layer also can function as a diffusion layer to diffuse light transmitted through the polarizing plate in order to widen the viewing angle (i.e., visually-compensating function).

The antireflection layer, the anti-sticking layer, the diffusion layer and the anti-glare layer mentioned above can be laminated on the polarizing plate, as a sheet of optical layers comprising these layers, separately from the protective layer.

Also, the polarizing plate may include other optical layers, for example, a reflector, a semitransparent reflector, a brightness enhancement film and the like. These optical layers may be used alone or in combination of two or more layers. The optical layer can be a monolayer or a laminate of plural layers. Such an integral polarizing plate will be described below.

First, an example of the reflective polarizing plate or the semitransparent reflective polarizing plate will be described. The reflector is further provided to the polarizer and the protective layer in order to form a reflective polarizing plate, and the semitransparent reflector is further provided to the polarizer and the protective layer in order to form a semitransparent reflective polarizing plate.

For example, such a reflective polarizing plate is arranged on a backside of a liquid crystal cell and used in a liquid crystal display that reflects incident light from a visible side (display side) (a reflective liquid crystal display). The reflective polarizing plate has some merits, for example, assembling of light sources such as backlight can be omitted, and the liquid crystal display can be thinned further.

The reflective polarizing plate can be formed in any known manner such as forming a reflector of metal or the like on one surface of the polarizing plate. For example, a protective layer of the polarizing plate is prepared by matting one surface (exposed surface) if required. On this surface, a foil comprising a reflective metal such as aluminum or a deposition film is applied to form a reflective polarizing plate.

An additional example of a reflective polarizing plate comprises the above-mentioned protective layer of various transparent resins having a surface of a microscopic asperity due to contained fine particles, and also a reflector corresponding to the microscopic asperity. The reflector having a microscopic asperity surface diffuses incident light by irregular reflection so that directivity and glare can be prevented and irregularity in color tones can be controlled. This reflector can be formed by disposing a metal foil or a metal deposition film directly on a microscopic asperity surface of the protective layer in any conventionally known methods including deposition such as vacuum deposition, and plating such as ion plating and sputtering.

Alternatively, the reflector can be a reflecting sheet formed by providing a reflecting layer onto a proper film similar to the protective film. Since a typical reflecting layer of a reflector is made of a metal, it is preferable in use of the reflector that the reflecting surface of the reflecting layer is coated with a film, a polarizing plate or the like in order to prevent the reflection rate from lowering due to oxidation. As a result, the initial reflection rate is maintained for a long period, and a separate protective layer can be omitted.

A semitransparent polarizing plate is provided by replacing the reflector in the above-mentioned reflective polarizing plate by a semitransparent reflector, and it is exemplified by a half mirror that reflects and transmits light at the reflecting layer.

For example, such a semitransparent polarizing plate is arranged on a backside of a liquid crystal cell. In a liquid crystal display comprising the semitransparent polarizing plate, incident light from the visible side (display side) is reflected to display an image when the liquid crystal display is used in a relatively bright atmosphere, while in a relatively dark atmosphere, an image is displayed by using a built-in light source such as a backlight in the backside of the semitransparent polarizing plate. In other words, the semitransparent polarizing plate can be used to form a liquid crystal display that can save energy for a light source such as a backlight under a bright atmosphere, while a built-in light source can be used under a relatively dark atmosphere.

Now, an example of a polarizing plate obtained by further laminating the polarizer and the protective layer with a brightness enhancement film will be described.

The brightness enhancement film is not particularly limited but can be a film having a property of transmitting linearly polarized light with a predetermined polarization axis and reflecting other light, for example, a dielectric multilayer thin film or a multilayer laminate of thin films with different refractive index anisotropies. Such a brightness enhancement film is, for example, trade name “D-BEF” manufactured by 3M Corporation. It also is possible to use a cholesteric liquid crystal layer, especially an aligned film of a cholesteric liquid crystal polymer, and this aligned liquid crystal layer supported on a film base. For example, a brightness enhancement film utilizing the combination of selective reflection of the cholesteric liquid crystal and a so-called λ/4 plate is preferable. These films exhibit a property of reflecting one of right and left circularly polarized lights and transmitting the other light and are, for example, trade name “PCF350” manufactured by Nitto Denko Corporation or trade name “Transmax” manufactured by Merck Ltd. Other than the above, a scattering film utilizing anisotropic scattering according to its polarization direction and a so-called wire grid polarizer can be listed as the brightness enhancement film.

The optical element of the present invention can be produced by any conventionally known method without particular limitation. For example, it can be produced by a suitable lamination of individual constituent elements such as the polyimide film, the polarizer, the protective layer, etc. Although there is no particular limitation on the lamination method, it is possible to employ a method of laminating the above-noted constituent element via a layer of a pressure-sensitive adhesive, an adhesive or the like. It should be noted that, although there is no clear distinction between the “adhesive” and the “pressure-sensitive adhesive” in the present invention, an adhesive that allows bonded objects to peel off from each other or re-bond to each other relatively easily among the other adhesives is referred to as the “pressure-sensitive adhesive,” for the sake of convenience. The kind of the pressure-sensitive adhesive or the adhesive is not particularly limited but can be determined suitably depending on materials of the above-noted constituent elements. For example, it is possible to use a polymer adhesive based on acrylic substances, vinyl alcohol, silicone, polyester, polyurethane or polyether, or a rubber-based adhesive. It also is possible to use an adhesive containing a water-soluble cross-linking agent of vinyl alcohol-based polymers such as boric acid, borax, glutaraldehyde, melamine and oxalic acid. The pressure-sensitive adhesive and the adhesive mentioned above do not peel off easily even when being exposed to moisture or heat, for example, and have excellent light transmittance and polarization degree. More specifically, these pressure-sensitive adhesive and adhesive preferably are PVA-based adhesives when the polarizer is a PVA-based film, in light of stability of adhering treatment. Also, the adhesive and pressure-sensitive adhesive may have pressure sensitivity. These adhesive and pressure-sensitive adhesive may be applied directly to surfaces of the polarizer and the protective layer, or a layer of a tape or a sheet formed of the adhesive or pressure-sensitive adhesive may be arranged on the surfaces thereof. Further, when these adhesive and pressure-sensitive adhesive are prepared as an aqueous solution, for example, other additives or a catalyst such as an acid catalyst may be blended as necessary. In the case of applying the adhesive, other additives or a catalyst such as an acid catalyst further may be blended in the aqueous solution of the adhesive. The thickness of the adhesive layer is not particularly limited but may be, for example, 1 to 500 nm, preferably 10 to 300 nm, and more preferably 20 to 100 nm.

In some cases, instead of using the adhesive or pressure-sensitive adhesive, the lamination can be conducted by directly forming a certain constituent element on another constituent element by coating or the like. For example, when a polarizer is laminated with the polyimide film of the present invention, it may be possible to prepare a laminate of the polyimide film and a plastic base and then bond only the polyimide film onto the polarizer by transferring or to form the polyimide film of the present invention directly onto the polarizer by coating.

Each of the polarizer, the protective layer, the optical layer and the pressure-sensitive adhesive layer that form the optical element of the present invention as described above may be treated suitably with an UV absorber such as salicylate ester compounds, benzophenone compounds, benzotriazole compounds, cyanoacrylate compounds or nickel complex salt-based compounds, thus providing an UV absorbing capability.

The optical element of the present invention also can be produced by laminating each constituent element on a liquid crystal cell surface or the like sequentially in each production process of a liquid crystal display, for example. However, it is more preferable to prepare an optical element of the present invention by the lamination of the individual constituent elements and use it for producing the liquid crystal display because there is an advantage in that excellent quality stability and assembling operability are achieved, leading to an improvement in the efficiency in producing a liquid crystal display.

It is preferable that the optical element of the present invention further has the pressure-sensitive adhesive layer or the adhesive layer described above on one or both of its outer surfaces because easier lamination onto other members such as a liquid crystal cell can be achieved. The pressure-sensitive adhesive layer or the like can be a monolayer or a laminate. The laminate can include monolayers different from each other in the compositions or in the types. When arranged on both surfaces of the optical element, the pressure-sensitive adhesive layers or the like can be the same or can be different from each other in compositions or types. In the case where a surface of the pressure-sensitive adhesive layer or the like provided on the optical element is exposed, it is preferable to cover the above-noted surface with a separator so as to prevent contamination until the pressure-sensitive adhesive layer or the like is put to use. The separator can be made by coating a suitable film with a peeling coat of a peeling agent such as a silicone-based agent, a long-chain alkyl-based agent, a fluorine-based agent, an agent comprising molybdenum sulfide or the like as necessary. The material for the film is not particularly limited but can be similar to that for the protective layer, for example.

There is no particular limitation on how to use the optical element of the present invention. However, the optical element is suitable for use in various image display apparatuses, for example, arranged on the surface of a liquid crystal cell.

The image display apparatus of the present invention includes at least one of the polyimide film of the present invention, the optical film of the present invention and the optical element of the present invention, thus achieving an excellent image display performance. Other than the above, there is no particular limitation on the image display apparatus of the present invention. Its production method, configuration, use etc. can be selected arbitrarily and suitably from conventionally known modes.

The kind of the image display apparatus of the present invention is not particularly limited but preferably is a liquid crystal display. For example, it is possible to arrange the optical film or the optical element of the present invention on one surface or both surfaces of the liquid crystal cell so as to form a liquid crystal panel and to use it in a reflection-type, semi-transmission-type or transmission and reflection type liquid crystal display. The kind of the liquid crystal cell forming the liquid crystal display can be selected arbitrarily. For example, it is possible to use any type of liquid crystal cells such as an active-matrix driving type represented by a thin-film transistor type, or a simple-matrix driving type represented by a twisted nematic type or a super twisted nematic type.

A typical liquid crystal cell is composed of opposing liquid crystal cell substrates and a liquid crystal injected into a space between the substrates. The liquid crystal cell substrates can be made of glass, plastics or the like without any specific limitations. Materials for the plastic substrates can be selected from conventionally known materials without any specific limitations.

Further, the polyimide film, the optical film or the optical element of the present invention may be provided on one surface or both surfaces of the liquid crystal cell. When members such as the optical element are provided on both surfaces of the liquid crystal cell, they can be the same or different in kind. Moreover, for producing a liquid crystal display, one or at least two layers of appropriate members such as a prism array sheet, a lens array sheet, an optical diffuser and a backlight can be arranged at proper positions.

The structure of the liquid crystal panel in the liquid crystal display according to the present invention is not particularly limited. However, it is preferable that the liquid crystal cell, the polyimide film of the present invention, the polarizer and the transparent protective layer are included, for example, and one surface of the liquid crystal cell is laminated with the polyimide film, the polarizer and the protective layer in this order. In the case where the polyimide film of the present invention is formed on the plastic base, the polyimide film side can face the liquid crystal cell, while the plastic base side can face the polarizer, for example, though there is no particular limitation on their arrangement.

In the case where the liquid crystal display of the present invention further includes a light source, this light source preferably is a flat light source emitting polarized light so as to use light energy effectively, though there is no specific limitation.

Furthermore, the polyimide film, the optical film and the optical element according to the present invention are not limited to a use in the liquid crystal display described above but also can be used in self-light-emitting displays such as an organic electroluminescence (EL) display, a plasma display (PD) and an FED (field emission display). When used in self-light-emitting flat displays, the polyimide film of the present invention can be utilized as an antireflection filter because it can obtain circularly polarized light by setting its in-plane retardation to be λ/4.

The following is a description of an electroluminescence (EL) display according to the present invention. The EL display of the present invention has the polyimide film, the optical film or the optical element of the present invention and may be either an organic EL display or an inorganic EL display.

In recent years, for EL displays, it has been suggested to use an optical film such as a polarizer or a polarizing plate together with a λ/4 plate for preventing reflection from an electrode in a black state. The polyimide film, the optical film and the optical element of the present invention are very useful particularly when any of linearly polarized light, circularly polarized light and elliptically polarized light is emitted from the EL layer, or when obliquely emitted light is polarized partially even if natural light is emitted in the front direction.

The following description is directed to a typical organic EL display. In general, an organic EL display has a luminant (organic EL luminant) that is prepared by laminating a transparent electrode (an anode), an organic luminant layer and a metal electrode (a cathode) in a certain order on a transparent substrate. Here, the organic ruminant layer is a laminate of various organic thin films. Known examples thereof include a laminate of a hole injection layer made of triphenylamine derivative or the like and a ruminant layer made of a fluorescent organic solid such as anthracene; a laminate of the ruminant layer and an electron injection layer made of perylene derivative or the like; or a laminate of the hole injection layer, the ruminant layer and the electron injection layer.

The organic EL display emits light on the following principle: a voltage is applied to the anode and the cathode so as to inject holes and electrons into the organic ruminant layer, and re-bonding of these holes and electrons generates energy. Then, this energy excites the fluorescent substance, which emits light when it returns to the basis state. The mechanism of the re-bonding is similar to that of an ordinary diode. This implies that current and the light emitting intensity exhibit a considerable nonlinearity accompanied with a rectification with respect to the applied voltage.

It is necessary for the organic EL display that at least one of the electrodes is transparent so as to obtain luminescence at the organic ruminant layer. In general, a transparent electrode of a transparent conductive material such as indium tin oxide (ITO) is used for the anode. Use of substances having small work function for the cathode is important for facilitating the electron injection and thereby raising luminous efficiency, and in general, metal electrodes such as Mg—Ag, and Al—Li may be used.

In an organic EL display configured as described above, it is preferable that the organic luminant layer is made of a film that is extremely thin such as about 10 nm. Therefore, the organic luminant layer can transmit substantially whole light as the transparent electrode does. As a result, when the layer does not illuminate, a light beam entering from the surface of the transparent substrate and passing through the transparent electrode and the organic ruminant layer before being reflected at the metal layer comes out again to the surface of the transparent substrate. Thereby, the display surface of the organic EL display looks like a mirror when viewed from the outside.

The organic EL display according to the present invention preferably includes, for example, the polyimide film, the optical film or the optical element according to the present invention on the surface of the transparent electrode. With this configuration, the organic EL display has an effect of suppressing external reflection and improving visibility or the like. For example, the optical element of the present invention including the polyimide film and the polarizing plate functions to polarize light which enters from outside and is reflected by the metal electrode, and thus the polarization has an effect that the mirror of the metal electrode cannot be viewed from the outside. Particularly, the mirror of the metal electrode can be blocked completely by forming the polyimide film of the present invention with a quarter wavelength plate and adjusting an angle formed by the polarization directions of the polarizing plate and the polyimide film to be π/4. That is, the polarizing plate transmits only the linearly polarized light component among the external light entering the organic EL display. In general, the linearly polarized light is changed into elliptically polarized light by the polyimide film. However, when the polyimide film is a quarter wavelength plate and when the above-noted angle is π/4, the light is changed into circularly polarized light.

For example, this circularly polarized light passes through the transparent substrate, the transparent electrode, and the organic thin film. After being reflected by the metal electrode, the light passes again through the organic thin film, the transparent electrode and the transparent substrate, and turns into linearly polarized light at the retardation film. Moreover, since the linearly polarized light crosses the polarization direction of the polarizing plate at a right angle, it cannot pass through the polarizing plate. As a result, the mirror of the metal electrode can be blocked completely as mentioned earlier.

### EXAMPLES

Now, examples of the present invention will be described. It should be noted that the present invention is not limited by the examples below.

(Measurement Condition etc.)

2,2-bis(3,4-dicarboxyphenyl)-hexafluoropropane dianhydride manufactured by Clariant (Japan) K.K. and 2,2-bis(trifluoromethyl)-4,4′-diaminobiphenyl manufactured by WAKAYAMA SEIKA KOGYO., LTD. were used. All the other chemicals were purchased from Wako Pure Chemical Industries, Ltd. LA400 (trade name) manufactured by JEOL. Ltd. was used for ¹HNMR measurement, and FT/IR-230 (trade name) manufactured by JASCO International Co., Ltd. was used for IR measurement. In the ¹HNMR measurement, analyses were made such that the peak near 11 ppm was assigned to NH in a polyamic acid and the peak at 7.0 to 8.5 ppm was assigned to an aromatic ring in a polyamic acid and polyimide. In the IR measurement, analyses were made such that the peak near 1730 cm⁻¹ was assigned to a C═O double bond in an imido bond, the peak near 1687 cm⁻¹ was assigned to a C═O double bond in an amido bond, and the peak near 1537 cm⁻¹ was assigned to a N—H single bond in an amido bond. The weight-average molecular weight Mw was measured using HLC-8120GPC (trade name) manufactured by TOSOH CORPORATION. Polymers to be measured were dissolved in DMF (dimethylformamide) to prepare a 0.1 wt % solution before measurement, and DMF was used for an eluant. After the measurement, Mw and the number-average molecular weight Mn were calculated in terms of polystyrene standard. The birefringence Δn at a wavelength of 590 nm was measured using KOBRA21ADH (trade name) manufactured by Oji Scientific Instruments, and the refractive indices nx, ny and nz were calculated from the measurement value by a usual method. The fracture strength was measured using AUTOGRAPH AG-10KNI (trade name) manufactured by Shimadzu Corporation. The imidization ratio was calculated based on the equation (4) below, where X indicates an integral of the peak near 11 ppm and Y indicates an integral of the peak at 7.0 to 8.5 ppm in the ¹HNMR measurement. In the equation (4), A indicates the imidization ratio.
A(%)=((Y−6X)/Y)×100 (4)

### Example 1

First, polyimide was synthesized. More specifically, an oil bath and a reactor obtained by attaching a stirring device, a Dean-Stark trap, a nitrogen introducing tube, a thermometer and a condenser to a 500 mL separable flask were first prepared. Next, 17.77 g (40 mmol) of 2,2-bis(3,4-dicarboxyphenyl)-hexafluoropropane dianhydride and 12.81 g (40 mmol) of 2,2-bis(trifluoromethyl)-4,4′-diaminobiphenyl were put into the flask. While stirring at 600 rpm, a solution prepared by dissolving 2.58 g (20 mmol) of isoquinoline in 275.21 g of m-cresol was added further. After stirring at room temperature for 1 hour, the content of the flask became a uniform solution. Subsequently, the stirring speed was changed to 300 rpm, the temperature of the oil bath was set to 180° C., and the flask was dipped in this oil bath so that the temperature inside the flask was maintained to range from 175° C. to 180° C. Further heating and stirring allowed the content to become a yellow solution gradually. 3 hours later, heating and stirring was stopped and the content was allowed to cool down to room temperature, so that polymer precipitated in a gel form.

Next, 2 L of isopropyl alcohol was prepared and stirred at 5000 rpm. On the other hand, the above-described content of the flask was put into another container, to which acetone was added to achieve a polyimide concentration of 7 wt %. The gel was dissolved completely by stirring. This was added little by little to the isopropyl alcohol while stirring, so that powder precipitated. This powder was collected by filtration, put into 1.5 L of isopropyl alcohol, and then washed by stirring again at 5000 rpm for 5 minutes. Furthermore, the above washing process was repeated once again, and the powder was collected by filtration again. This was pre-dried in a hot-air circulating drier at 60° C. for 48 hours and then dried at 150° C. for 7 hours, thereby obtaining a desired polyimide in white powder form (yield: 85%).

Thereafter, a polyimide film was produced using this polyimide. More specifically, the polyimide first was dissolved in cyclopentanone (solubility parameter: 21.3), thus preparing a 20 wt % solution. On the other hand, a 70 μm thick TAC (triacetylcellulose) film was prepared for use as a base. The polyimide solution was applied on this base and dried at 130° C. for 5 minutes, thereby forming a 6 μm thick polyimide coating film. Then, this coating film was uniaxially stretched by 10% at 150° C. together with the base, thus obtaining a desired polyimide film layered on the base. This polyimide film was transparent and smooth and had a thickness of 5 μm. Incidentally, “uniaxially stretched by 10%” refers to the process in which the length of the stretched film along the stretching direction was 110% of that of the pre-stretched film.

### Example 2

First, polyimide was synthesized. More specifically, 2,2-bis(3,4-dicarboxyphenyl)-hexafluoropropane dianhydride was first pre-dried as follows: after dried at 160° C. for 6 hours, it was gradually cooled down to 80° C. in the drier and then stored in a desiccator box. Next, an oil bath and a reactor obtained by attaching a silica gel tube, a stirring device and a thermometer to a well-dried 3 L separable flask were prepared. Then, 75.52 g (170 mmol) of the above-noted 2,2-bis(3,4-dicarboxyphenyl)-hexafluoropropane dianhydride and 54.44 g (170 mmol) of 2,2-bis(trifluoromethyl)-4,4′-diaminobiphenyl were put into this flask. While stirring this at 400 rpm, 519.84 g of DMAc (dehydration grade) was added, and stirring was continued until the content of the flask became a uniform solution. Subsequently, using the oil bath to adjust the temperature inside the container to range from 20° C. to 60° C., the stirring was continued for 20 hours, thereby allowing a reaction to produce a polyamic acid. At this time, as the reaction proceeded, the viscosity increased, which made it difficult to stir the content at a high speed. Accordingly, the stirring speed was dropped gradually. After 20 hours of stirring, the temperature of the reaction system was brought down to room temperature, and 649.8 g of DMAc was added such that the polymer concentration was adjusted to be 10 wt %. Furthermore, 32.27 g of pyridine (408 mmol) and then 41.65 g (408 mmol) of acetic anhydride were allowed to drop over about 10 minutes each, and stirred at room temperature to allow a reaction for imidization. How the reaction proceeded was traced by IR, and the stirring was continued until the peak near 1537 cm⁻¹ disappeared. It was confirmed that the peak disappeared 10 hours later, and then the stirring was stopped and the reaction was brought to an end.

Next, 20 L of isopropyl alcohol was prepared and stirred at 5000 rpm. On the other hand, the above-described content of the flask was put into another container, to which 700 g of acetone was added to achieve a polyimide concentration of 6.5 wt %. This was added little by little to the isopropyl alcohol while stirring, so that powder precipitated. This powder was collected by filtration, put into 15 L of isopropyl alcohol, and then washed by stirring again at 5000 rpm for 5 minutes. Furthermore, the powder was collected by filtration again, pre-dried in a hot-air circulating drier at 60° C. for 48 hours and then dried at 150° C. for 7 hours, thereby obtaining a desired polyimide in white powder form (yield: 93%).

Moreover, a polyimide film was produced using this polyimide powder similarly to Example 1. The resultant polyimide film was transparent and smooth and had a thickness of 5 μm.

### Example 3

First, polyimide powder was synthesized similarly to Example 1. Next, a 20 wt % polyimide solution was prepared similarly to Example 1 except that cyclopentanone was replaced with methyl isobutyl ketone (solubility parameter: 17.2). Thereafter, a polyimide film was produced similarly to Example 1. The resultant polyimide film was transparent and smooth and had a thickness of 5 μm.

### Example 4

First, polyimide powder was synthesized similarly to Example 1. Next, a 20 wt % polyimide solution was prepared similarly to Example 1 except that cyclopentanone was replaced with ethyl acetate (solubility parameter: 18.6). Thereafter, a polyimide film was produced similarly to Example 1. The resultant polyimide film was transparent and smooth and had a thickness of 5 μm.

### Example 5

First, polyimide powder was synthesized similarly to Example 1. Next, a 20 wt % polyimide solution was prepared similarly to Example 1 except that cyclopentanone was replaced with N-methylpyrrolidone (solubility parameter: 23.1). Thereafter, a polyimide film was produced similarly to Example 1. This polyimide film had a thickness of 5 μm.

### Comparative Example

Polyimide powder was synthesized similarly to Example 1 except that isoquinoline was not added and the stirring time after heating was 2 hours (yield: 88%). Furthermore, using the obtained polyimide powder, a polyimide film was produced similarly to Examples 1 and 2. This polyimide film had a thickness of 5 μm.

### Reference Example

Polyimide powder was synthesized similarly to Example 2 except that the reaction was ended 2 hours after adding pyridine and acetic anhydride (yield: 90%).

(Physical Property of Polyimide)

The weight-average molecular weight Mw, the number-average molecular weight Mn and the imidization ratio of the polyimide powder synthesized in Examples 1 to 5, Comparative example and Reference example were measured. The results are altogether shown in Table 1 below.

TABLE 1

| | Mw | Mn | Mw/Mn | Imidization ratio |
|---|---|---|---|---|
| Example 1 | 62500 | 20000 | 3.1 | 100% |
| Example 2 | 136000 | 41000 | 3.3 | 100% |
| Comparative example | 35000 | 12000 | 2.9 | 72.6% |
| Reference example | 68700 | 18600 | 3.7 | 79.5% |

(Note:
polyimide powders of Examples 3 to 5 are the same as that of Example 1.)

The molecular weight of these polyimide powders was measured again after 1-year storage at normal temperature and at atmospheric pressure. The variation ratio of the molecular weight of the polyimide of Examples 1 to 5 was less than 10%, that of the polyimide of Comparative example was −45%, and that of the polyimide of Reference example was −40%. From these results, it is found that a low imidization ratio achieves only a low long-term storage stability.

(Refractive Index Anisotropy of Polyimide Film)

The birefringence of the polyimide films of Examples 1 to 5 and Comparative example was measured.

Before the measurement, each polyimide film was first transferred onto a glass substrate so as to obtain a laminate of the glass substrate and the polyimide film (hereinafter, referred to as a “glass-polyimide laminate”). More specifically, the glass substrate was first prepared, on which an adhesive (an acrylic adhesive manufactured by Nitto Denko Corporation) was applied. Furthermore, the applied surface and the polyimide film were brought into close contact with each other, and the base formed of TAC film was peeled off from the polyimide film, thereby obtaining a desired glass-polyimide laminate.

Using this glass-polyimide laminate, the birefringence of each polyimide film was measured. Then, from the measurement results, the principal refractive indices nx and ny in an in-plane direction and the refractive index nz in a thickness direction were calculated. The results are altogether shown in Table 2 below. It should be noted that the definitions of nx, ny and nz are the same as those in the formula (1) above.

TABLE 2

| | nx | ny | nz |
|---|---|---|---|
| Example 1 | 1.56078 | 1.54778 | 1.51649 |
| Example 2 | 1.56507 | 1.55757 | 1.50796 |
| Example 3 | 1.56078 | 1.54778 | 1.51649 |
| Example 4 | 1.56078 | 1.54778 | 1.51649 |
| Example 5 | 1.56078 | 1.54778 | 1.51649 |
| Comparative example | 1.56103 | 1.55777 | 1.51332 |

As becomes clear from Table 2, all the polyimide films of Examples 1 to 5 and Comparative example satisfied the relationship nx>ny>nz and had a biaxial optical anisotropy. When their appearances were observed, the polyimide films of Examples 1 to 4 were found to have a particularly good transparency and smoothness.

(Long-Term Storage Stability)

Glass-polyimide laminates respectively including the polyimide films of Examples 1 to 5 and Comparative example were produced similarly to the above. They were stored in a drier at 100° C. for 1000 hours, and the long-term storage stability of these polyimide films was evaluated. The polyimide film of Comparative example cracked and became no longer available for use.

(Fracture Strength)

The fracture strength of the polyimide films of Examples 1 to 5 and Comparative example was measured under the measurement condition of a pulling speed of 5 m/min, a sample width of 10 mm and a chuck-to-chuck distance of 50 mm.

Prior to the measurement, each of the polyimide films was separated from the TAC base. More specifically, each of the polyimide films was transferred onto a PET substrate similarly to the glass-polyimide laminate except for using the PET substrate instead of the glass substrate. Thereafter, the polyimide film alone was peeled off from the PET substrate. Then, the fracture strength of the polyimide film that had been peeled off was measured under the above-described measurement condition. Table 3 below shows the results altogether.

TABLE 3

| | Fracture strength (N/mm²) |
|---|---|
| Example 1 | 110 |
| Example 2 | 130 |
| Example 3 | 110 |
| Example 4 | 110 |
| Example 5 | 110 |
| Comparative example | 80 |

As becomes clear from Table 3, the fracture strengths of the polyimide films of Examples 1 to 5 were particularly high and all exceeded 100 N/mm².

### INDUSTRIAL APPLICABILITY

As described above, the present invention can provide a polyimide film that has a biaxial optical anisotropy and excellent durability. The optical film and the optical element according to the present invention include a polyimide layer formed of the polyimide film of the present invention and thus have excellent optical characteristics. Furthermore, the image display device of the present invention includes the polyimide film of the present invention and thus achieves excellent image display performance.

1. A polyimide film, comprising polyimide whose imidization ratio ranges from 98% to 100% and satisfying an optical characteristic condition represented by the formula (1) below, wherein nx, ny and nz respectively indicate refractive indices in an X-axis direction, a Y-axis direction and a Z-axis direction in the polyimide film, with the X axis corresponding to an axial direction exhibiting a maximum refractive index within a surface of the polyimide film, the Y axis corresponding to an axial direction perpendicular to the X axis within the surface, and the Z axis corresponding to a thickness direction perpendicular to the X axis and the Y axis.
nx>ny>nz (1)

2. The polyimide film according to claim 1, wherein the polyimide is polyimide whose molecule contains a fluorine atom.

3. The polyimide film according to claim 1, wherein the polyimide is polyimide obtained by allowing 2,2-bis(3,4-dicarboxyphenyl)-hexafluoropropane dianhydride and 2,2-bis(trifluoromethyl)-4,4′-diaminobiphenyl to react so as to produce a polyamic acid and then imidizing the polyamic acid.

4. The polyimide film according to claim 1, wherein the polyimide has a weight-average molecular weight ranging from 50000 to 180000.

5. The polyimide film according to claim 1, which has a fracture strength of equal to or greater than 100 N/mm² under a measurement condition of a pulling speed of 5 m/min, a sample width of 10 mm and a chuck-to-chuck distance of 50 mm.

6. An optical film, comprising a polyimide layer formed of the polyimide film according to claim 1.

7. An optical element, whose one surface or both surfaces are laminated with the polyimide film according to claim 1.

8. An image display apparatus, comprising the polyimide film according to claim 1.

9. A method for producing the polyimide film according to claim 1, comprising:
(A) the step of applying a solution of polyimide having an imidization ratio of 98% to 100% onto a plastic base and drying the solution, thus forming a polyimide coating; and
(B) the step of stretching the polyimide coating together with the plastic base so as to satisfy the formula (1) above.

10. The method according to claim 9, wherein the polyimide is polyimide whose molecule contains a fluorine atom.

11. The method according to claim 9, wherein the polyimide is polyimide obtained by allowing 2,2-bis(3,4-dicarboxyphenyl)-hexafluoropropane dianhydride and 2,2-bis(trifluoromethyl)-4,4′-diaminobiphenyl to react so as to produce a polyamic acid and then imidizing the polyamic acid.

12. The method according to claim 9, wherein a solvent of the polyimide solution has a solubility parameter ranging from 17 to 22 under a measurement condition of a pressure of 1 atmosphere and an atmospheric temperature of 25° C., with the solubility parameter being a value δ represented by the equation (2) below, wherein ΔH and V respectively indicate molar heat of vaporization and molar volume of the solvent.
δ=(ΔH/V)^{1/2} (2)

13. The method according to claim 9, wherein the temperature at which the polyimide solution is dried in the step (A) is equal to or lower than 200° C.

14. The method according to claim 9, wherein a solvent of the polyimide solution comprises at least one solvent selected from the group consisting of ester, ketone and ether.

15. The method according to claim 14, wherein the ester comprises at least one selected from the group consisting of ethyl acetate, propyl acetate, butyl acetate, isobutyl acetate, butyl propionate and caprolactone, the ketone comprises at least one selected from the group consisting of acetone, methyl ethyl ketone, methyl propyl ketone, methyl isopropyl ketone, methyl isobutyl ketone, diethyl ketone, cyclopentanone, cyclohexanone and methylcyclohexanone, and the ether comprises at least one selected from the group consisting of methyl ether (dimethyl ether), diethyl ether, dibutyl ether, dichloroethyl ether, furan, tetrahydrofuran, diphenyl ether, dibenzyl ether, ethylene glycol monoethyl ether, ethylene glycol butyl ether, propylene glycol methyl ether, diethylene glycol monobutyl ether and tripropylene glycol.

16. The method according to claim 9, wherein the plastic base comprises at least one selected from the group consisting of polyester, cellulose ester, polyolefin, substituted polyolefin, polycarbonate and polysulfone.

17. The method according to claim 16, wherein the polyester comprises at least one selected from the group consisting of polyethylene terephthalate, polyethylene isophthalate, 1,4-cyclohexanedimethylene terephthalate, polybutylene terephthalate and polyethylene naphthalate, the cellulose ester comprises at least one selected from the group consisting of triacetylcellulose, cellulose propionate and cellulose butyrate, the polyolefin comprises at least one selected from the group consisting of polynorbornene, polyethylene, polypropylene and polystyrene, the substituted polyolefin comprises at least one of isobutene-N-methylmaleimide copolymer and acrylonitrile-styrene copolymer, the polycarbonate comprises at least one selected from the group consisting of polycarbonate of bisphenol A, polycarbonate of bisphenol C (2,2-bis(4-hydroxyphenyl)-1,1-dichloroethylene), polycarbonate of alkylidenebisphenol and polycarbonate of cycloalkylidenebisphenol, the polysulfone comprises at least one selected from the group consisting of polyethersulfone, polyarylethersulfone, polyphenylsulfone and bisphenol A polysulfone.

18. An optical element, whose one surface or both surfaces are laminated with the optical film according to claim 6.

19. An image display apparatus, comprising the optical film according to claim 6.

20. An image display apparatus, comprising the optical element according to claim 7.
